(19) United States
(12) Patent Application Publication
(10) Pub. No.: US 2023/0411651 A1
(43) Pub. Date: Dec. 21, 2023

(54) A FLOW CELL BATTERY

(71) Applicant: Bryte AS, Saksvik (NO)

(72) Inventors: Brian STEAD, Ranheim (NO); Besart OLLURI, Trondheim (NO)

(73) Assignee: Bryte AS, Saksvik (NO)

(21) Appl. No.: 18/037,982

(22) PCT Filed: Nov. 19, 2021
(86) PCT No.: PCT/NO2021/050244

§ 371 Date: May 19, 2023

(30) Foreign Application Priority Data
Nov. 20, 2020 (NO) 20201263

(51) Int. Cl. H01M 8/04186; H01M 8/18

(52) U.S. Cl. CPC H01M 8/04186; H01M 8/18

(57) ABSTRACT

A flow cell battery comprising on at least one side of a cell stack; a top electrolyte tank, a bottom electrolyte tank and at least one intermediate electrolyte tank arranged therebetween. The top electrolyte tank is in fluid communication with the bottom electrolyte tank through the cell stack. A first fluid communication is provided between the at least one intermediate electrolyte tank and the top electrolyte tank for flowing therebetween. A second fluid communication is provided between the at least one intermediate electrolyte tank and the bottom electrolyte tank for flowing therebetween. The second fluid communication comprises a controllable fluid flow restrictor. Each of the top, bottom and tanks comprise at least one gas connection for flowing gas in and out of each respective tank. A flowing device is provided for controlling a flow of electrolyte between the tanks.

The present invention relates to flow cell batteries. More specifically, the disclosure relates to a flow cell battery comprising a top, bottom and intermediate electrolyte tank, as defined in claim 1.

### BACKGROUND

Flow cell batteries are well known in the art of storing energy. A flow cell battery is a rechargeable fuel cell and is unique from conventional batteries insomuch that the energy is stored in electrolytes and not in electrode materials.

Flow cell batteries have been predicted by various industries to be the ideal solution for large scale energy storage due to the low environmental impact and long life-time. Flow cell batteries are fire-proof, environmentally friendly, adaptable and easy to produce. However, there are two limiting factors for commercialization of known flow cell batteries; efficiency limitations and cost.

Moving the storage medium to a fluid allows for a decoupling between how much energy can be stored, capacity (Wh), and how much energy can be delivered at any one time, or power (W). This allows for adaptations to the battery's design to be able to meet the required demands of a storage system. The adaptations relate to the total volume of electrolytes in the system and the total reactive area in the cell stack where the chemical reactions take place. If high capacity is desired, then more electrolyte can be added. Likewise, power outputs can be increased by increasing the total reactive area, allowing for more contact between the electrolytes at any given time. Comparatively, other battery types such as lead, Li-ion and NiMh batteries are limited by the thermal dynamics of a cell and as such have a direct correlation between capacity and power.

Flow cell batteries can be classified under two categories: Redox and Concentration Gradient (CG). Both categories include a method to separate electrolytes from each other, an auxiliary system to circulate the electrolytes within the system and a cell stack to transform energy states.

Flow rate control is an important aspect for optimization of a flow cell battery. The flow rate of the electrolyte through the cell stack is determined by the ionic concentration of the reactants and the reaction speed over the membrane. This means that if the ionic concentration of reactants is low, then there are fewer ions on each side of the membrane which can react with each other. Therefore, to maintain a constant power output, the flow speed must be increased.

Redox flow batteries employ the difference in potential between two species of electrolyte. An electrolyte is a solution of salts and can conduct electricity. Salts are composed of a metal ion and a non-metal ion, which respectively are often positively and negatively charged. An ion is an atom with more or fewer electrons than protons and it is the electrons that enable electrical conductivity. An electrolyte will have a concentration of one or more salts, of which contribute to the electrical potential, or how attracted the electrolyte is to another electrolyte. A rule of thumb is that atoms (ions) want to reach the lowest state of energy as possible, so if an ion can obtain or lose part of it's potential, then it will do so through exchanging electrons with other atoms. These exchanges, or reactions are called a reduction and an oxidation; electrons are respectively added or removed from an ion, thus the name Redox. The transfer of electrons can occur through direct contact with other ions, yet this limits the ability to utilize the energy in the reaction. Therefore, an electrochemical cell is used to separate two differently charged electrolytes.

When the flow cell battery is connected to an energy source, this charges the battery and pulls the electrons from the positive solution, also known as oxidation. The same number of electrons are then pushed into the negative solution, which is referred to as reduction.

Contrarily, when the battery is connected to a load, the chain of reaction naturally runs the opposite direction due to the more stable state the ions may achieve. This necessitates electrons to move through said load generating a current. The multi-layer structure of cells is where the electrolytic reactions take place, and is called a cell stack. The voltage of a single cell is relatively low compared to the voltage of power grids; to obtain a serviceable voltage, multiple cells are connected in series to form a cell stack.

Unlike dry batteries, flow batteries decouple the energy storage capacity from the power generation capacity. Thus, the energy capacity depends on the size of the tanks, whereas the power capacity depends on the number of cells, which gives the advantage of power and energy capacities being more scalable compared to traditional sealed batteries.

In traditional flow batteries, the electrolyte solution represents, in many cases, over 50% of the costs, yet, 10-20% of the electrolytes remain unused in the charge and discharge cycles. Flow batteries are charged and discharged by electrolytes being pumped through the cell stack, which then return to the same tanks they originated from. Due to this mixing, the molecular concentration through the cell stack decreases and, correspondingly, the power output in or out of the battery. To maintain a stable power output, the electrolyte's flow must increase. This means higher pumping speeds, requiring more energy, ultimately decreasing the system efficiency.

Concentration Gradient Flow Batteries (CGFB) are similar to Redox Flow Batteries in regard to the need to separate electrolytes, yet the energy carrier lays within the difference in salt concentrations and not in the electrical potential between ion species. There are various types of CGFB, including Reverse Osmosis/Pressure Retarded Reverse Osmosis (RO-PRO), Electro-dialysis/Reverse Electrodyalysis (ED-RED) and Donnan Capacitance. These technologies are emerging as potential solutions for large-scale batteries, yet remains to be made even more economically and technologically feasible.

There is therefore a need for an improved flow cell battery to improve battery storage technology and to reduce or eliminate the above mentioned disadvantages of known techniques. It is an objective of the present invention to achieve this and to provide further advantages over the state of the art.

Documents useful for understanding the field of technology include US 2010003545 A1, WO 2012094672 A2, US 2019280316 A1, KR 20150141305 A, US 2004234843 A1, U.S. Pat. Nos. 4,786,567 A, 4,797,566 A and 4,362,791 A.

### SUMMARY

It is an object of the present invention to mitigate, alleviate or eliminate one or more of the above-identified deficiencies and disadvantages in the prior art and solve at least the above mentioned problem.

According to a first aspect, there is provided a flow cell battery comprising on at least one side of a cell stack:
a top electrolyte tank;
a bottom electrolyte tank arranged below the top electrolyte tank;
at least one intermediate electrolyte tank arranged between the top and bottom electrolyte tanks;
the top electrolyte tank is in fluid communication with the bottom electrolyte tank through the cell stack;
a first fluid communication between the at least one intermediate electrolyte tank and the top electrolyte tank for flowing electrolyte between the at least one intermediate electrolyte tank and the top electrolyte tank;
a second fluid communication between the at least one intermediate electrolyte tank and the bottom electrolyte tank for flowing electrolyte between the at least one intermediate electrolyte tank and the bottom electrolyte tank;
the second fluid communication comprises a controllable fluid flow restrictor; each of the top, bottom and at least one intermediate electrolyte tank comprise at least one gas connection for flowing gas in and out of each respective tank;
a flowing device for controlling a flow of electrolyte between the at least one intermediate electrolyte tank and the top electrolyte tank through the cell stack to the bottom electrolyte tank and the at least one intermediate electrolyte tank, and vice versa.

According to an embodiment of the invention, a top portion of an intermediate electrolyte tank is arranged below a bottom portion of the electrolyte tank arranged immediately above.

According to an embodiment of the invention, a bottom portion of an intermediate electrolyte tank is arranged above a top portion of the electrolyte tank arranged immediately below.

According to an embodiment of the invention, the first fluid communication is arranged between a bottom portion of the at least one intermediate electrolyte tank and a top portion of the top electrolyte tank.

According to an embodiment of the invention, the second fluid communication is arranged between a bottom portion of the at least one intermediate electrolyte tank and a bottom portion of the bottom electrolyte tank.

According to an embodiment of the invention, the gas connections are provided at top portions of each respective electrolyte tanks.

According to an embodiment of the invention, the flowing device is connected to the gas connections.

According to an embodiment of the invention, the gas connections of all the electrolyte tanks are connected at at least one gas restrictor.

According to an embodiment of the invention, the flowing device comprises a compressor and an accumulator.

According to an embodiment of the invention, the gas connection of the top electrolyte tank is connected to the gas connection of each of the at least one intermediate electrolyte tank thereby providing a third fluid communication between the top electrolyte tank and the at least one intermediate electrolyte tank;
the gas connection of the bottom electrolyte tank is connected to the gas connection of each of the at least one intermediate electrolyte tank thereby providing a fourth fluid communication between the bottom electrolyte tank and the at least one intermediate electrolyte tank;
the third and fourth fluid communications are provided with controllable fluid flow restrictors.

According to an embodiment of the invention, the flowing device is arranged between the cell stack and the bottom electrolyte tank.

According to an embodiment of the invention, an additional fluid communication is provided between each at least one intermediate electrolyte tank and the bottom electrolyte tank through the cell stack.

According to an embodiment of the invention, the flowing device comprises a pump.

According to an embodiment of the invention, the fluid flow restrictors comprises valves.

According to an embodiment of the invention, the flow cell battery comprises on at least one side of the cell stack a plurality of intermediate electrolyte tanks arranged on top of each other.

According to an embodiment of the invention, the flow cell battery comprises on at least one side of the cell stack one intermediate electrolyte tank.

According to a second aspect, there is provided a method of flowing electrolyte on at least one side of a cell stack in a flow cell battery by displacement of gas the method comprising the steps of:
a first step of flowing gas out of the bottom electrolyte tank and flowing gas into the at least one intermediate electrolyte tank arranged immediately above such that electrolyte is displaced to the top electrolyte tank and electrolyte is flowed through the cell stack to the bottom electrolyte tank;
a second step of flowing gas out of the intermediate electrolyte tank filled with gas and flowing gas into the electrolyte tank arranged immediately above such that electrolyte is flowed from the bottom electrolyte tank and into the intermediate electrolyte tank being emptied of gas.

According to an embodiment of the invention, the first and second steps are performed simultaneously.

According to an embodiment of the invention, the second step is repeated until the intermediate electrolyte tank arranged immediately above is the top electrolyte tank and the flow cell battery is fully discharged.

According to an embodiment of the invention, the method may be reversed.

According to an embodiment of the invention, the method is reversed until the bottom electrolyte tank is generally filled with gas and the flow cell battery is fully charged.

A flow cell battery according to the invention, comprises less volume of gas relative to the volume of electrolyte. As the number of intermediate electrolyte tanks increases, the ratio between gas and electrolyte increases accordingly. Because of the arrangement of electrolyte tanks provided on top of each other, the flowing device used to flow the electrolytes through the cell stack may be much less powerful and thereby require much less energy to run, compared to flowing devices used in traditional flow cell batteries. Because at least three separate electrolyte tanks are provided in the flow cell battery, all the electrolyte in the flow cell battery can be utilized efficiently, and discharged electrolyte does not mix with the charged electrolyte, ensuring a 100% efficiency rate of the electrolyte.

The invention uses partly the flow principles of Heron's fountain, where fluid is drawn from a topmost fluid tank and because of the arrangement of fluid tanks in a vertical direction relative to one another, emptying fluid from the topmost tank to a bottommost tank creates a positive pressure in the bottommost tank that forces fluid from at least one intermediate tank up to the topmost tank, etc.

Most flow cell batteries operate best at temperatures between 20-80° C. as the thermal energy increases the chemical reaction efficiency by matching or exceeding the activation energy. Heat produced internally can be used in the flow cell battery for pre-warming the electrolyte and/or contributing to pressure management in the flow cell battery. The internal heat may not be suffice enough to affect the electrochemical efficiency and the battery may therefore benefit from external heat sources such as the sun or excess heat from industry buildings.

The flow cell battery can store electrochemical energy, and it may also be suitable for storing thermal energy. The thermal energy can be exchanged in and out of the flow cell battery with heat-exchangers to and from external sources. This can potentially allow for a symbiosis between the flow cell battery and a structure where thermal management is necessary.

Thermal energy, either produced internally within the flow cell battery, or from an external source, can contribute to the controlling the gas pressure in the flow cell battery. The correlation between temperature and pressure is direct; an increase in temperature increases the pressure of a gas and vice versa.

The present invention will become apparent from the detailed description given below. The detailed description and specific examples disclose preferred embodiments of the invention by way of illustration only. Those skilled in the art understand from guidance in the detailed description that changes and modifications may be made within the scope of the invention.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an” and “the” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings do not exclude other elements or steps.

### BRIEF DESCRIPTION OF THE DRAWINGS

The above objects, as well as additional objects, features and advantages of the present invention, will be more fully appreciated by reference to the following illustrative and non-limiting detailed description of example embodiments of the present invention, when taken in conjunction with the accompanying figures.

FIG. 1a shows a perspective view of a first embodiment of a flow cell battery in a fully charged state.

FIGS. 1b-1d show perspective views of the flow cell battery being discharged.

FIG. 1e shows a perspective view of the flow cell battery in a fully discharged state.

FIG. 2a shows a perspective view of a second embodiment of a flow cell battery in a fully charged state.

FIGS. 2b-2d show a perspective view of the flow cell battery being discharged.

FIG. 2e shows a perspective view of the flow cell battery in a fully discharged state.

FIG. 3 shows a perspective view of a third embodiment of a flow cell battery where the intermediate electrolyte tanks are connected through the cell stack.

FIG. 4 shows a perspective view of a fourth embodiment of the flow cell battery where the intermediate electrolyte tanks are connected through the cell stack.

FIG. 5 shows a perspective view of a fifth embodiment of the flow cell battery comprising a plurality intermediate electrolyte tanks.

### DETAILED DESCRIPTION

The present invention will now be described with reference to the accompanying drawings, in which preferred example embodiments of the invention are shown. The invention may, however, be embodied in other forms and should not be construed as limited to the herein disclosed embodiments. The disclosed embodiments are provided to fully convey the scope of the invention to the skilled person.

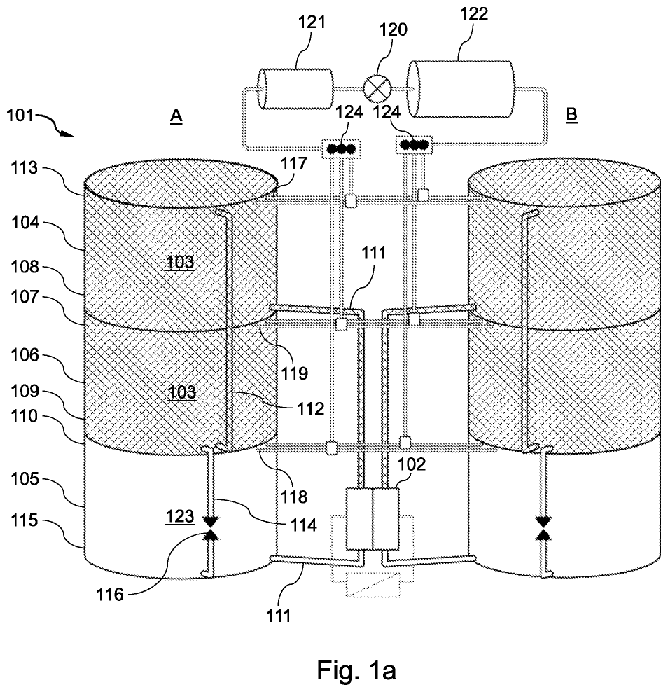

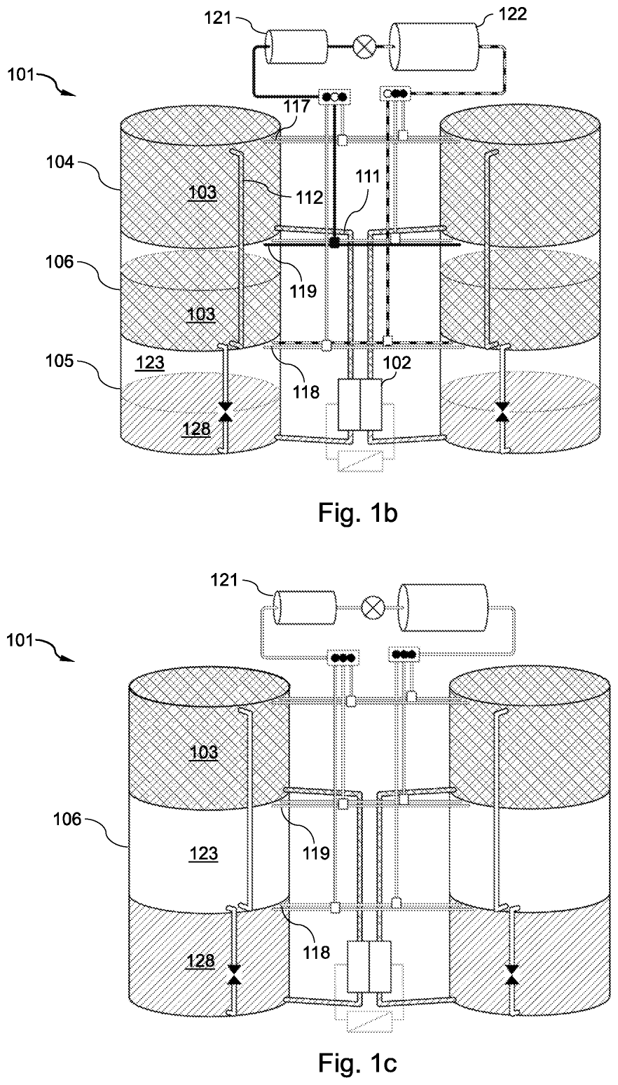

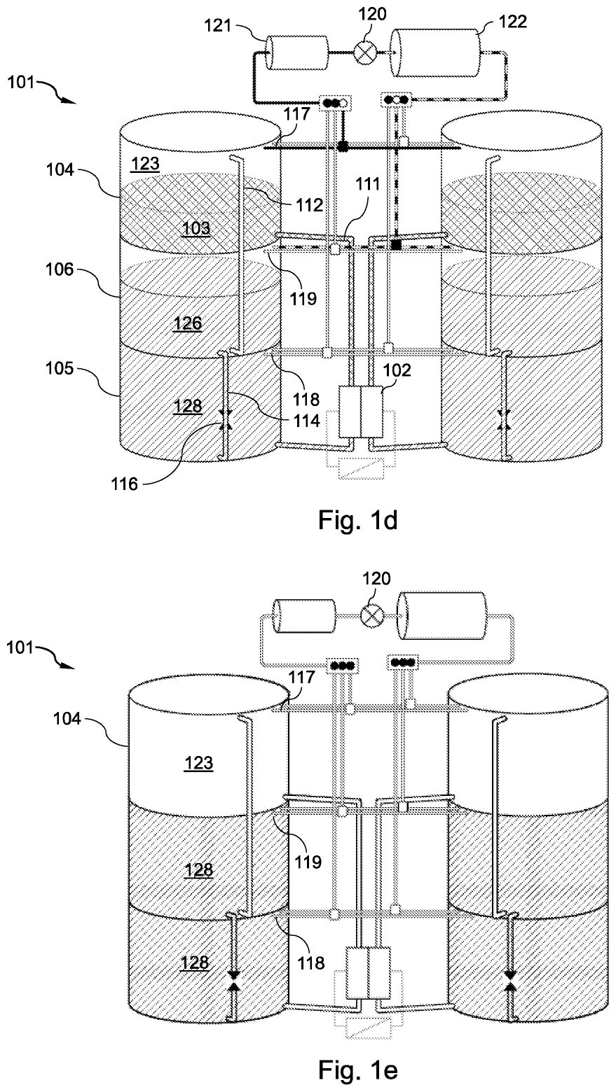

Referring initially to FIG. 1a, a first embodiment of a flow cell battery 101 in a fully charged state is shown. The flow cell battery 101 comprises a cell stack 102. Electrolyte 103 may flow through the cell stack 102 in order to generate electricity. The flow cell battery 101 comprises a first side A and a second side B of the cell stack 102. In the following, only the first side A of the flow cell battery 101 is described in detail, but the flow cell battery 101 may be symmetrical about the cell stack 102, such that the description is applicable to the second side B as well.

The flow cell battery 101 comprises a top electrolyte tank 104, a bottom electrolyte tank 105 and at least one intermediate electrolyte tank 106. In the first illustrated embodiment, the flow cell battery 101 comprises one intermediate electrolyte tank 106. The at least one intermediate electrolyte tank 106 is arranged between the top and bottom electrolyte tanks 104,105. The electrolyte tanks 104,105,106 do as such not need to be stacked directly above one another. A fully charged state as indicated in FIG. 1a occurs when the bottom electrolyte tank 105 is empty of electrolyte, but the remaining electrolyte tanks 104,106 are filled with electrolyte.

The electrolyte tanks 104,105,106 may be made from steel, composite materials, or similar. They are as such designed to hold a predetermined amount of electrolyte, and also contain a predetermined amount of pressurized gas. The electrolyte tanks 104,105,106 may as such be fluid tight containers, and must be able to contain both liquid and gas. The volume of the electrolyte tanks 104,105,106 need not be the same, such that the electrolyte tanks 104,105,106 may vary in size.

In one preferred embodiment, a top portion 107 of the at least one intermediate electrolyte tank 106 is arranged below a bottom portion 108 of the electrolyte tank arranged immediately above. In the illustrated embodiment, because there is only one intermediate electrolyte tank 106, the electrolyte tank arranged immediately above the at least one intermediate electrolyte tank 106 is the top electrolyte tank 104.

In another preferred embodiment, a bottom portion 109 of the at least one intermediate electrolyte tank 106 is arranged above a top portion 110 of the electrolyte tank arranged immediately below. In the illustrated embodiment, because there is only one intermediate electrolyte tank 106, the electrolyte tank arranged immediately below the at least one intermediate electrolyte tank 106 is the bottom electrolyte tank 105.

The top electrolyte tank 104 is in fluid communication 111 with the bottom electrolyte tank 105 through the cell stack 102. A fluid communication 111 is thus provided between the top electrolyte tank 104 and the bottom electrolyte tank 105 through the cell stack 102. As electrolyte 103 is flowed from the top electrolyte tank 104 through the cell stack 102 to the bottom electrolyte tank 105, electricity may be generated. The fluid communication 111 may be a pipe, tube, or similar member configured for leading a flow of electrolyte through the cell stack 102.

A first fluid communication 112 is provided between the at least one intermediate electrolyte tank 106 and the top electrolyte tank 104. The first fluid communication 112 is provided for flowing electrolyte 103 between the at least one intermediate electrolyte tank 106 and the top electrolyte tank 104. The first fluid communication 112 is preferably arranged between the bottom portion 109 of the at least one intermediate electrolyte tank 106 and a top portion 113 of the top electrolyte tank 104. Because the first fluid communication 112 is provided at the bottom portion 109, all the electrolyte 103 may thus be drained from the intermediate electrolyte tank 106. The first fluid communication 112 may thus most preferably be provided at the very bottom of the at least one intermediate electrolyte tank 106. The first fluid communication 112 may also be a pipe, tube, or similar member configured for leading a flow of electrolyte from the at least one intermediate electrolyte tank 106 to the top electrolyte tank 104.

A second fluid communication 114 is provided between the at least one intermediate electrolyte tank 106 and the bottom electrolyte tank 105. The second fluid communication 114 is provided for flowing electrolyte 103 between the at least one intermediate electrolyte tank 106 and the bottom electrolyte tank 105. The second fluid communication 114 is preferably arranged between the bottom portion 109 of the at least one intermediate electrolyte tank 106 and a bottom portion 115 of the bottom electrolyte tank 105. Because the second fluid communication 114 is provided at the bottom portion 109, all the electrolyte 103 may thus be drained from the intermediate electrolyte tank 106. The second fluid communication 114 may thus most preferably be provided at the very bottom of the at least one intermediate electrolyte tank 106. Similarly, the second fluid communication 114 may preferably be provided at the bottom portion 115 of the bottom electrolyte tank 105, such that all the electrolyte 103 may be drained from the bottom electrolyte tank 105 if the flow is reversed. The second fluid communication 112 may be a pipe, tube, or similar member configured for leading a flow of electrolyte from the at least one intermediate electrolyte tank 106 to the bottom electrolyte tank 105.

The second fluid communication 114 comprises a controllable fluid flow restrictor 116. The controllable fluid flow restrictor 116 may be a valve or similar means for limiting a fluid flow through the second fluid communication 114. The fluid flow restrictor 116 may e.g. be turned on and off upon receiving a signal, such that electrolyte 103 is allowed or prevented to flow through the second fluid communication 114, and thus between the at least one intermediate electrolyte tank 106 and the bottom electrolyte tank 105. The controllable fluid flow restrictor 116 is preferably a two-way valve.

Each of the top, bottom and at least one intermediate electrolyte tanks 104,105,106 comprise at least one gas connection 117,118,119. The top electrolyte tank 104 comprises a top tank gas connection 117, the bottom electrolyte tank 105 comprises a bottom tank gas connection 118 and the at least one intermediate electrolyte tank 106 comprises an intermediate electrolyte tank gas connection 119. In the first embodiment of the flow cell battery 101, the gas connections 117,118,119 are connected to a flowing device 120. The gas connections 117,118,119 may be a single connection like e.g. a pipe or a tube allowing gas to flow in and out of each respective tank 104,105,106. The gas connections 117,118,119 may also be twin connections as illustrated, where one connection is provided solely for flowing gas into its respective electrolyte tank, and the other connection is provided solely for flowing gas out of its respective electrolyte tank.

The gas connections 117,118,119 are preferably provided at top portions 113,107,110 of each respective electrolyte tanks 104,105,106. I.e. the gas connection 117 at the top electrolyte tank 104 is provided at the top portion 113 of the top electrolyte tank 104, the gas connection 118 at the bottom electrolyte tank 105 is provided at the top portion 110 of the bottom electrolyte tank 105 and the gas connection 119 at the at least one intermediate electrolyte tank 106 is provided at the top portion 107 of the at least one intermediate electrolyte tank 106. As the gas connections are provided at the top portions of each respective electrolyte tank, all the gas in each electrolyte tank can be flowed out, and the electrolyte tank may be filled with electrolyte.

The flow cell battery 101 comprises a flowing device 120. The flowing device 120 controls the flow of electrolyte 103 in the flow cell battery 101. The flowing device 120 thus controls the flow of electrolyte 103 between the at least one intermediate electrolyte tank 106 and the top electrolyte tank 104 through the cell stack 102. From the cell stack 102 the flow of electrolyte 103 is flowed to the bottom electrolyte tank 105 and the at least one intermediate electrolyte tank 106. This process is described more in detail later, and may also be reversed.

The flowing device 120 may be configured for controlling both sides A,B of the flow cell battery 101. Alternatively, one side A of the flow cell battery 101 may comprise one flowing device 120, and the other side B may comprise another flowing device. A flowing device may also be connected to each of the electrolyte tanks. The flow cell battery 101 may as such comprise any number of flowing devices 120.

The flowing device 120 may be connected to the gas connections 117,118,119 as in the first embodiment. The flowing device 120 of the first embodiment is thus connected to all the electrolyte tanks 104,105,106, and the gas connections 117,118,119 of all the electrolyte tanks are also connected. The flowing device 120 is configured for flowing gas 123 in and out of the electrolyte tanks 104,105,106. Gas 123 may be pumped into an electrolyte tank in order to displace electrolyte 103, or gas 123 may be pumped out of an electrolyte tank in order to generate an under pressure and thus allow for electrolyte to enter the electrolyte tank.

The flowing device 120 may be a pump, and in the first embodiment, the flowing device 120 additionally comprises a compressor 121 and an accumulator 122. The flowing device 120 may as such be any device capable of creating an negative pressure and a positive pressure. The gas connections 117,118,119 must be able to be sealed off, or prevent gas 123 from escaping or entering the respective electrolyte tanks 104,105,106. The electrolyte 103 or gas 123 may as such be maintained in each respective electrolyte tank 104,105,106. In the first embodiment, this is achieved by gas restrictors 124. The gas restrictors 124 of the first embodiment are arranged after the compressor 121 and before the accumulator 122. The gas restrictors 124 may be controlled to ensure the intended flow of gas 123 in and out of the electrolyte tanks 104,105,106 through the gas connections 117,118,119. The gas restrictors 124 may as such be arranged in various places in the flow cell battery 101. In the following, controlling the gas restrictors 124 is also referred to as opening and closing the gas connections 117,118,119.

In the following, a cycle of discharging a flow cell battery 101 according to the first embodiment is explained.

FIG. 1a: When a flow cell battery 101 is fully charged, the top and at least one intermediate electrolyte tanks 104,106 are filled with charged electrolyte 103. The bottom electrolyte tank 105 is empty of electrolyte 103, and may be filled with pressurized gas 123. The fluid flow restrictor 116 is closed, and the flowing device 120 may be off.

FIG. 1b: To initiate discharge of the flow cell battery 101, the bottom gas connection 118 is opened in such a way as to release high pressure gas 123 from the top of the bottom electrolyte tank 105 to the accumulator 122. This allows for electrolyte 103 from the top electrolyte tank 104 to flow through the fluid communication 111 and cell stack 102. In the cell stack 102, the electrolyte 103 alter the state-of-charge to discharged electrolyte 128. Simultaneously, the intermediate gas connection 119 is opened in such a way that pressurized gas 123 from the compressor tank 121 can enter the at least one intermediate electrolyte tank 106. Thus, the electrolyte 103 in the at least one intermediate tank 106 is displaced upward via the first fluid connector 112 to the top electrolyte tank 104. The flow rate of the electrolyte 103 is regulated by the flowing device 120. This first phase continues until the at least one intermediate tank 106 is empty of electrolyte 103 and filled with gas 123.

FIG. 1c: Before continuing to the next phase of discharging the flow cell battery 101, the bottom gas connection 118 is closed as well as the intermediate gas connection 119 such that gas 123 from the compressor tank 121 is prevented from entering the at least one intermediate tank 106.

FIG. 1d: To initate the last phase of discharging the flow cell battery 101, the fluid flow restrictor 116 must open to permit the flow of discharged electrolyte 128 from the bottom electrolyte tank 105 to the at least one intermediate electrolyte tank 106 via the second fluid connector 114. Simultaneously, the gas connector 119 from the at least one intermediate tank 106 is opened in such a way as to release the high pressure gas 123 from the at least one intermediate tank 106 to the accumulator 122. Additionally, the gas connector 117 is opened in such a way as to allow the flow of gas 123 from the compressor 121 into the top electrolyte tank 104. The flow rate of the electrolyte 103 is regulated by the flowing device 120. This last phase continues until the top electrolyte tank 104 is generally empty of electrolyte 103 and generally filled with gas 123.

FIG. 1e: The flow cell battery 101 is considered discharged when the top electrolyte tank 104 is generally empty of electrolyte 103 and generally filled with gas 123. The flowing device 120 is off and the gas connections 117, 118 and 119 are closed.

The flow cell battery 101 may be charged by reversing the process.

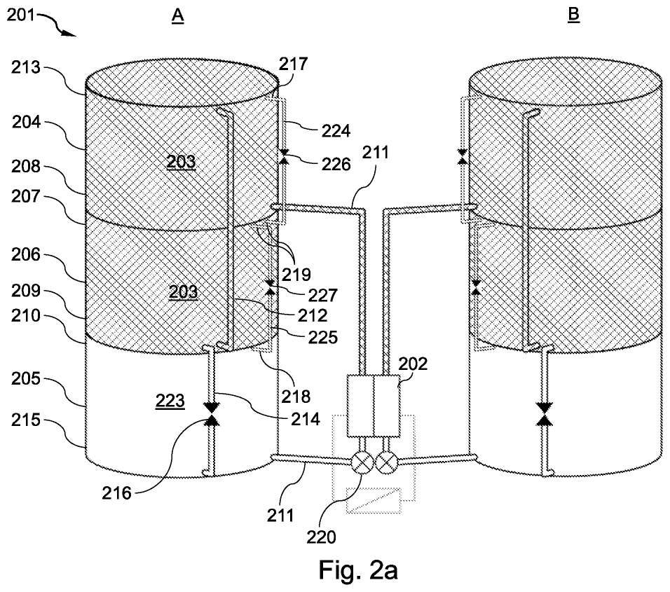

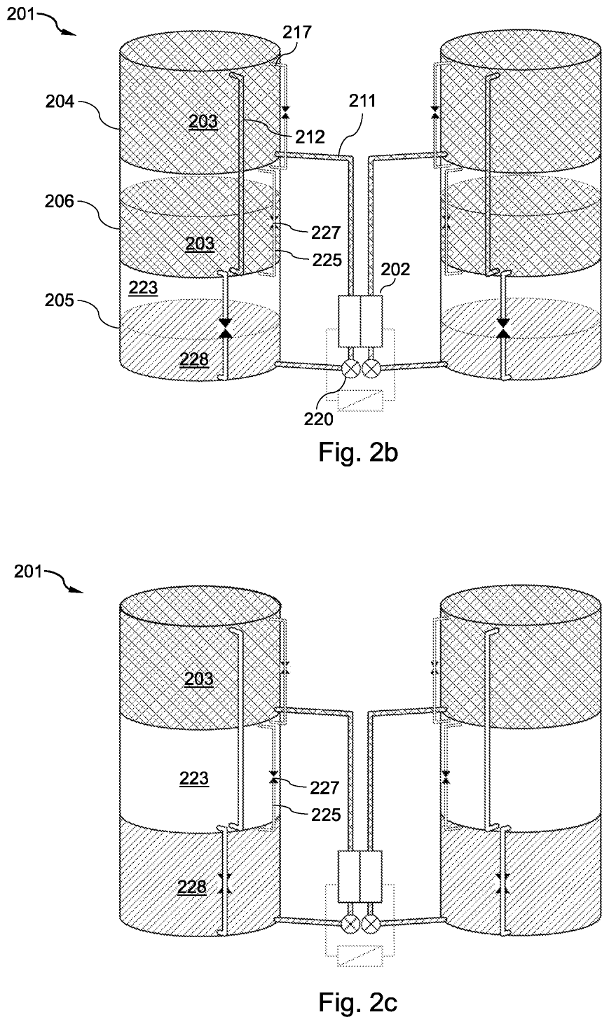

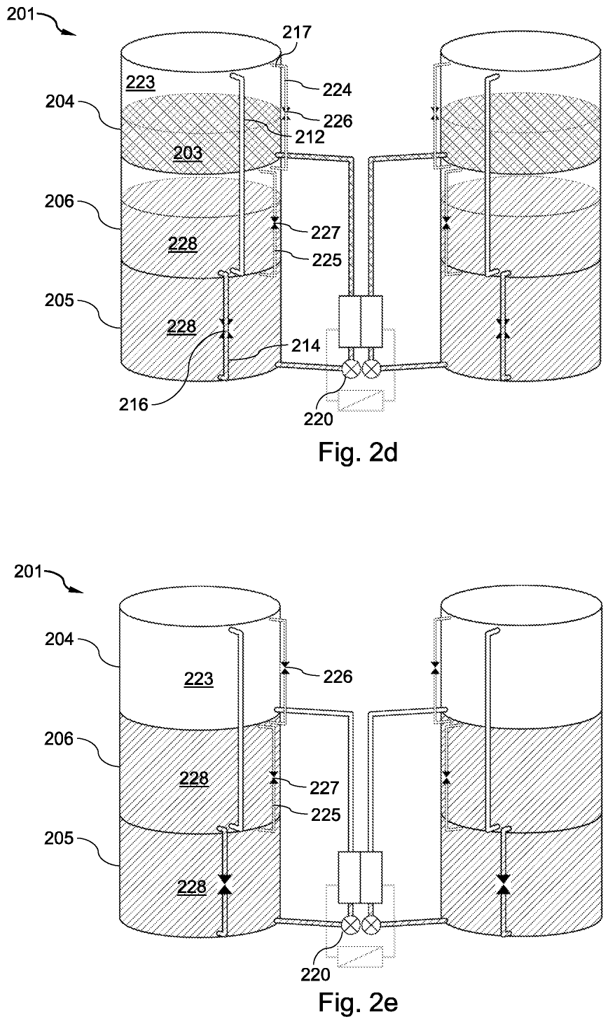

Referring now to FIG. 2a, a second embodiment of a flow cell battery 201 in a fully charged state is shown. Similarly to the first embodiment, the flow cell battery 201 comprises a cell stack 202, and electrolyte 203 may flow through the cell stack 102 in order to generate electricity. The flow cell battery 201 comprises a first side A and a second side B of the cell stack 202. In the following, only the first side A of the flow cell battery 201 is described in detail, but the flow cell battery 201 may be symmetrical about the cell stack 202, such that the description is applicable to the second side B as well.

Unless described otherwise, features described with reference to the first embodiment are valid for the second embodiment as well. Some features of the second embodiment similar to the first embodiment is not described in detail, but differences are highlighted in the following. Corresponding features of the first and second embodiments are denoted with corresponding last two digits in the reference numbers.

The flow cell battery 201 comprises a top electrolyte tank 204, a bottom electrolyte tank 205 and at least one intermediate electrolyte tank 206. In the second illustrated embodiment, the flow cell battery 201 comprises one intermediate electrolyte tank 206. The at least one intermediate electrolyte tank 206 is arranged between the top and bottom electrolyte tanks 204,205. The electrolyte tanks 204,205,206 do as such not need to be stacked directly above one another. A fully charged state as indicated in FIG. 2a occurs when the bottom electrolyte tank 205 is empty of electrolyte, but the remaining electrolyte tanks 204,206 are filled with electrolyte.

The top electrolyte tank 204 is in fluid communication 211 with the bottom electrolyte tank 205 through the cell stack 202. A fluid communication 211 is thus provided between the top electrolyte tank 204 and the bottom electrolyte tank 205 through the cell stack 202.

A first fluid communication 212 is provided between the at least one intermediate electrolyte tank 206 and the top electrolyte tank 204, and a second fluid communication 214 is provided between the at least one intermediate electrolyte tank 206 and the bottom electrolyte tank 205.

The second fluid communication 214 comprises a controllable fluid flow restrictor 216. The controllable fluid flow restrictor 216 may also be a valve or similar means for limiting a fluid flow through the first fluid communication 214. The fluid flow restrictor 216 may e.g. be turned on and off upon receiving a signal, such that electrolyte 203 is allowed or prevented to flow through the second fluid communication 214 and thus between the at least one intermediate electrolyte tank 206 and the bottom electrolyte tank 205. The controllable fluid flow restrictor 216 is preferably a two-way valve.

Each of the top, bottom and at least one intermediate electrolyte tanks 204,205,206 comprise at least one gas connection 217,218,219. The top electrolyte tank 204 comprises a top tank gas connection 217, the bottom electrolyte tank 205 comprises a bottom tank gas connection 218 and the at least one intermediate electrolyte tank 206 comprises at least one intermediate electrolyte tank gas connection 219.

The gas connections 217,218,219 are preferably provided at top portions 213,207,210 of each respective electrolyte tanks 204,205,206. I.e. the gas connection 217 at the top electrolyte tank 204 is provided at the top portion 213 of the top electrolyte tank 204, the gas connection 218 at the bottom electrolyte tank 205 is provided at the top portion 210 of the bottom electrolyte tank 205 and the gas connection 219 at the at least one intermediate electrolyte tank 206 is provided at the top portion 207 of the at least one intermediate electrolyte tank 206. If the gas connections are provided at the top portions of each respective electrolyte tank, all the gas in each electrolyte tank can easily be flowed out, and the electrolyte tank may be filled with electrolyte.

In the second embodiment of the flow cell battery 201, the gas connection of the top electrolyte tank 217 is connected to a gas connection of each of the at least one intermediate electrolyte tank 219. A third fluid communication 224 is thus provided between the top electrolyte tank 204 and the at least one intermediate electrolyte tank 206. Further, the gas connection of the bottom electrolyte tank 218 is connected to a gas connection of each of the at least one intermediate electrolyte tank 219. A fourth fluid communication 225 is thus provided between the bottom electrolyte tank 205 and the at least one intermediate electrolyte tank 206.

The third and fourth fluid communications 224,225 allow a flow of gas between the electrolyte tanks. The illustrated second embodiment shows two intermediate electrolyte tank gas connections 219, but these two could alternatively be combined into one intermediate electrolyte tank gas connection 219. The top and at least one intermediate electrolyte tanks 204,206 are thus in fluid communication through the gas connection 217 and gas connection 219, and the bottom and at least one intermediate electrolyte tanks 205,206 are thus in fluid communication through the gas connection 217 and gas connection 219.

In addition, the third fluid communication 224 is provided with a controllable fluid flow restrictor 226, and the fourth fluid communication 225 is provided with a controllable fluid flow restrictor 227. The controllable fluid flow restrictors 226,227 may be valves or similar means for limiting a gas flow through the third and fourth fluid communications 224,225. The valves are preferably two-way valves.

In the second embodiment, the flowing device 220 may comprise a pump, and the flowing device 220 may be arranged between the cell stack 202 and the bottom electrolyte tank 205. The flowing device 220 is preferably a reversible device, such as a reversible pump. The process can thereby be reversed and discharged electrolyte may be charged. The volume of gas 223 in the flow cell battery 201 must be equal to the volume of the largest electrolyte tank 204, 205, 206, if the electrolyte tanks are of different volumes.

In the following, a cycle of discharging a flow cell battery 201 according to the second embodiment is explained.

FIG. 2a: When a flow cell battery 201 is fully charged, the top and at least one intermediate electrolyte tanks 204,206 are filled with charged electrolyte 203. The bottom electrolyte tank 205 is empty of electrolyte 203, and may be filled with pressurized gas 223. The fluid flow restrictor 216 is closed and the flowing device 220 may be off.

FIG. 2b: To initiate discharge of the flow cell battery 201, the fourth fluid communication 225 is opened via a gas restrictor 227 in such a way as to release high pressure gas 223 from the bottom electrolyte tank 205, through the fourth fluid communication 225 to the at least one intermediate electrolyte tank 206. This allows for electrolyte 203 from the top electrolyte tank 204 to flow through the fluid communication 211 and the cell stack 202. In the cell stack 202, the electrolyte 203 alter the state-of-charge to discharged electrolyte 228. Simultaneously, the electrolyte 203 in the at least one intermediate tank 206 is displaced upward via the first fluid connector 212 to the top electrolyte tank 204. The flow rate of the electrolyte 203 is regulated by the flowing device 220. This first phase continues until the at least one intermediate tank 206 is generally empty of electrolyte 203 and generally filled with gas 223.

FIG. 2c: Before continuing to the next phase of discharging the flow cell battery 201, the fourth fluid communication 225 is closed via the gas restrictor 227.

FIG. 2d: To initate the last phase of discharging the flow cell battery 201, the fluid flow restrictor 216 must open to permit the flow of electrolyte 203 from the bottom electrolyte tank 205 to the at least one intermediate electrolyte tank 206 via the second fluid connector 214. Simultaneously, the third fluid communication 224 from the at least one intermediate tank 206 is opened via the fluid flow restrictor 226 in such a way as to release the high pressure gas 223 from the at least one intermediate tank 206 to top electrolyte tank 204. The flow rate of the electrolyte 203 is regulated by the flowing device 220. This last phase continues until the top electrolyte tank 204 is generally empty of electrolyte 203 and generally filled with gas 223.

FIG. 2e: The flow cell battery 201 is considered discharged when the top electrolyte tank 204 is generally empty of electrolyte 203 and generally filled with gas 223. The flowing device 220 may be off and the controllable fluid flow restrictors 226,227 are closed.

The flow cell battery 201 may be charged by reversing the process.

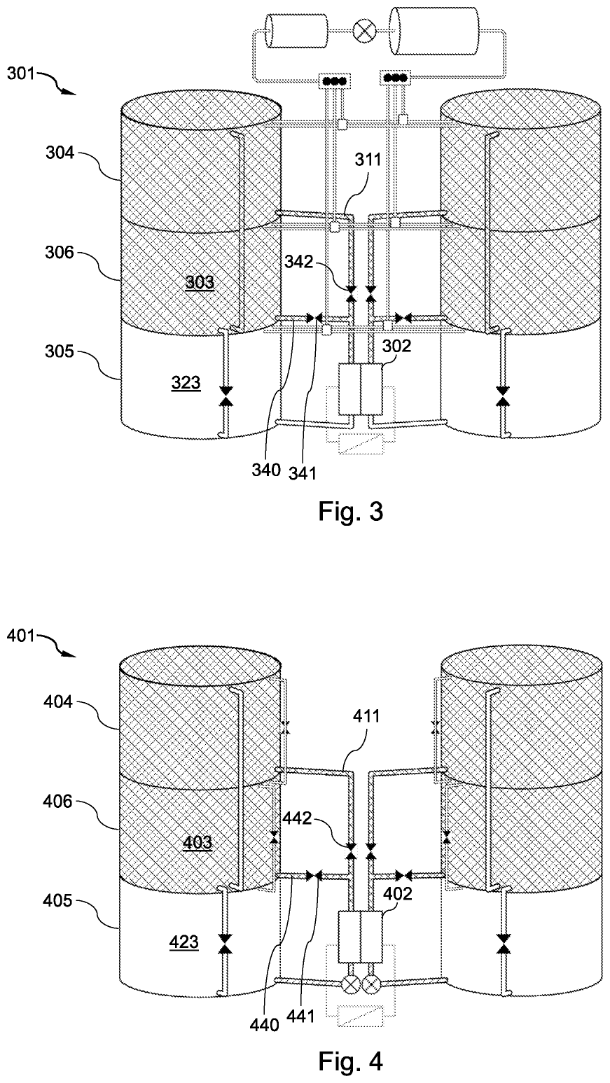

Referring now to FIG. 3, a third embodiment of a flow cell battery 301 is shown. The third embodiment is similar to the first embodiment, but an additional fluid communication 340 is provided between each of the at least one intermediate electrolyte tank 306 and the bottom electrolyte tank 305 through the cell stack 302.

The additional fluid communication 340 enables electrolyte 303 to flow from the at least one intermediate electrolyte tank 306 through the cell stack 302 to the bottom electrolyte tank 305. A controllable fluid flow restrictor 341 is provided on the additional fluid communication 340 such that the flow of electrolyte 303 through the additional fluid communication 340 can be controlled and stopped, if necessary.

A controllable fluid flow restrictor 342 is also provided on the fluid communication 311 between the top electrolyte tank 304 and the bottom electrolyte tank 305 through the cell stack 302.

Electrolyte 303 can thus be flowed from the at least one intermediate electrolyte tank 306 via the additional fluid communication 340 through the cell stack 302 to the bottom tank 305. This process can continue until the at least one intermediate electrolyte tank 306 is generally filled with gas 323 and the bottom electrolyte tank 305 is generally filled with electrolyte 303. The pursuant flow pattern is similar to the prosess detailed for FIGS. 1d-e.

Referring now to FIG. 4, a fourth embodiment of a flow cell battery 401 is shown. The fourth embodiment is similar to the second embodiment, but an additional fluid communication 440 is provided between each at least one intermediate electrolyte tank 406 and the bottom electrolyte tank 405 through the cell stack 402. The additional fluid communication 440 enables electrolyte 403 to flow from the at least one intermediate electrolyte tank 406 through the cell stack 402 to the bottom electrolyte tank 405. A controllable fluid flow restrictor 441 is provided on the additional fluid communication 440 such that the flow of electrolyte 403 through the additional fluid communication 440 can be controlled and stopped, if necessary.

A controllable fluid flow restrictor 442 is also provided on the fluid communication 411 between the top electrolyte tank 404 and the bottom electrolyte tank 405 through the cell stack 402.

Electrolyte 403 can thus be flowed from the at least one intermediate electrolyte tank 406 via the additional fluid communication 440 through the cell stack 402 to the bottom tank 405. This process can continue until the at least one intermediate electrolyte tank 406 is generally filled with gas 423 and the bottom electrolyte tank 405 is generally filled with electrolyte 403. The pursuant flow pattern is similar to the prosess detailed for FIGS. 2d-e.

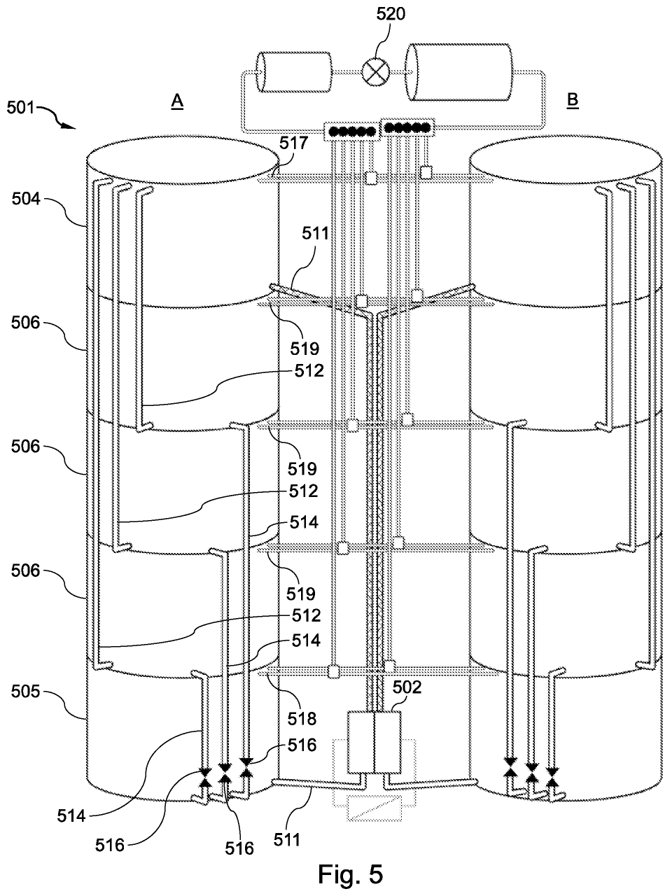

Referring now to FIG. 5, a fifth embodiment of a flow cell battery 501 is shown. The fifth embodiment is identical to the first embodiment, but with a plurality of intermediate electrolyte tanks 506. The fifth embodiment comprises three intermediate electrolyte tanks 506. In FIG. 5, all the electrolyte tanks are illustrated empty, but the flow cell battery 501 would in a fully charged state comprise electrolyte in all the electrolyte tanks 504,506 except the bottom electrolyte tank 505.

The fifth embodiment of the flow cell battery 501 comprises on at least one side A of a cell stack 502 a top electrolyte tank 504 and a bottom electrolyte tank 505 arranged below the top electrolyte tank 504. Three intermediate electrolyte tanks 506 are arranged between the top and bottom electrolyte tanks 504,505. The top electrolyte tank 504 is in fluid communication 511 with the bottom electrolyte tank 505 through the cell stack 502. Three first fluid communications 512 are arranged between the three intermediate electrolyte tanks 506 and the top electrolyte tank 504 for flowing electrolyte (not shown) between the three intermediate electrolyte tanks 506 and the top electrolyte tank 504. Three second fluid communications 514 are arranged between the three intermediate electrolyte tanks 506 and the bottom electrolyte tank 505 for flowing electrolyte between the three intermediate electrolyte tanks 506 and the bottom electrolyte tank 505. The second fluid communications 514 each comprise a controllable fluid flow restrictor 516. Each of the top, bottom and intermediate electrolyte tanks 504,505,506 comprise a gas connection 517,518,519 for flowing gas in and out of each respective tank 504,505,506. A flowing device 520 for controlling a flow of electrolyte between the three intermediate electrolyte tanks 506 and the top electrolyte tank 504 through the cell stack 502 to the bottom electrolyte tank 505 and the three intermediate electrolyte tanks 506, and vice versa.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed invention, from a study of the drawings, the disclosure, and the appended claims.

1. An electrolyte tank system for a flow cell battery, the electrolyte tank system comprising:
a top electrolyte tank;
a bottom electrolyte tank arranged below the top electrolyte tank;
one or more intermediate electrolyte tanks arranged between the top and bottom electrolyte tanks;
a respective first fluid communication between each intermediate electrolyte tank and the top electrolyte tank for flowing electrolyte between each intermediate electrolyte tank and the top electrolyte tank; and
a respective second fluid communication between each intermediate electrolyte tank and the bottom electrolyte tank for flowing electrolyte between the bottom electrolyte tank and each intermediate electrolyte tank;
wherein:
the top electrolyte tank comprises an outlet for fluid communication with the bottom electrolyte tank through a cell stack of the flow cell battery; wherein:
each of the top, bottom and each intermediate electrolyte tank comprises at least one respective gas connection for flowing gas in and/or out of the respective tank; and
the electrolyte tank system further comprises a flowing system for controlling a flow of electrolyte from each intermediate electrolyte tank to the top electrolyte tank, and from the top electrolyte tank, through the cell stack, to the bottom electrolyte tanks, and from the bottom electrolyte tank to each intermediate electrolyte tank.

2. The electrolyte tank system of claim 1, wherein a top portion of an intermediate electrolyte tank of the one or more intermediate electrolyte tanks is arranged immediately below a bottom portion of the top electrolyte tank.

3. The electrolyte tank system of claim 1, wherein a bottom portion of an intermediate electrolyte tank of the one or more intermediate electrolyte tanks is arranged immediately above a top portion of the bottom electrolyte tank.

4. The electrolyte tank system of claim 1, wherein the respective first fluid communication is arranged between a bottom portion of each intermediate electrolyte tank and a top portion of the top electrolyte tank.

5. The electrolyte tank system of claim 1, wherein the second fluid communication is arranged between a bottom portion of each intermediate electrolyte tank and a bottom portion of the bottom electrolyte tank.

6. The electrolyte tank system of claim 1, wherein the gas connections are provided at respective top portions of the respective electrolyte tanks.

7. The electrolyte tank system of claim 1, wherein the flowing system is connected to each of the gas connections.

8. The electrolyte tank system of claim 1, wherein each gas connection is connected to at least one respective gas restrictor.

9. The electrolyte tank system of claim 1, wherein the flowing system comprises a compressor and an accumulator.

10. The electrolyte tank system of claim 1, wherein:
the gas connection of the top electrolyte tank is connected to the gas connection of each of electrolyte tank thereby providing a respective third fluid communication between the top electrolyte tank and the intermediate electrolyte tank;
the gas connection of the bottom electrolyte tank is connected to the gas connection of each intermediate electrolyte tank thereby providing a respective fourth fluid communication between the bottom electrolyte tank and each intermediate electrolyte tank; and
the respective third and fourth fluid communications are provided with respective controllable fluid flow restrictors.

11. (canceled)

12. The electrolyte tank system of claim 1, wherein a respective additional fluid communication is provided between each intermediate electrolyte tank and the bottom electrolyte tank through the cell stack.

13. The electrolyte tank system of claim 1, wherein the flowing system comprises a pump.

14. (canceled)

15. The electrolyte tank system of claim 1, comprising a plurality of intermediate electrolyte tanks arranged on top of each other.

16. (canceled)

17. A method of flowing electrolyte through a cell stack of a flow cell battery by displacement of gas, wherein the flow cell battery comprises:
a cell stack; and
an electrolyte tank system,
wherein the electrolyte tank system comprises:
a top electrolyte tank;
a bottom electrolyte tank arranged below the top electrolyte tank;
one or more intermediate electrolyte tanks arranged between the top and bottom electrolyte tanks;
a respective first fluid communication between each intermediate electrolyte tank and the top electrolyte tank for flowing electrolyte between each intermediate electrolyte tank and the top electrolyte tank; and
a respective second fluid communication between each intermediate electrolyte tank and the bottom electrolyte tank for flowing electrolyte between the bottom electrolyte tank and each intermediate electrolyte tank;
wherein:
the top electrolyte tank comprises an outlet for fluid communication with the bottom electrolyte tank through a cell stack of the flow cell battery;
wherein each of the top, bottom and each intermediate electrolyte tank comprises at least one respective gas connection for flowing gas in and/or out of the respective tank; and
the electrolyte tank system further comprises a flowing system for controlling a flow of electrolyte from each intermediate electrolyte tank to the top electrolyte tank, and from the top electrolyte tank, through the cell stack, to the bottom electrolyte tank, and from the bottom electrolyte tank to each intermediate electrolyte tank,
the method comprising:
a first step of flowing gas out of the bottom electrolyte tank and flowing gas into an electrolyte-containing intermediate electrolyte tank of the one or more intermediate electrolyte tanks, arranged immediately above the bottom electrolyte tank, such that electrolyte is displaced from the electrolyte-containing intermediate electrolyte tank and electrolyte is flowed from the top electrolyte tanks through the cell stack to the bottom electrolyte tank; and
a second step of flowing gas out of a gas-containing intermediate electrolyte tank of the one or more intermediate electrolyte tanks and flowing gas into an electrolyte tank arranged immediately above the gas-containing intermediate electrolyte tank such that electrolyte is flowed from the bottom electrolyte tank and electrolyte is flowed into the intermediate electrolyte tank.

18. The method of claim 17, wherein the electrolyte-containing intermediate electrolyte tank is different from the gas-containing intermediate electrolyte tank, and wherein the first and second steps are performed simultaneously.

19-21. (canceled)

22. The electrolyte tank system of claim 1, wherein the second fluid communication comprises a controllable fluid flow restrictor.

23. A flow cell battery comprising:
a cell stack; and
an electrolyte tank system,
wherein the electrolyte tank system comprises:
a top electrolyte tank;
a bottom electrolyte tank arranged below the top electrolyte tank;
one or more intermediate electrolyte tanks arranged between the top and bottom electrolyte tanks;
a respective first fluid communication between each intermediate electrolyte tank and the top electrolyte tank for flowing electrolyte between each intermediate electrolyte tank and the top electrolyte tank; and
a respective second fluid communication between each intermediate electrolyte tank and the bottom electrolyte tank for flowing electrolyte between the bottom electrolyte tank and each intermediate electrolyte tank;
wherein:
the top electrolyte tank comprises an outlet for fluid communication with the bottom electrolyte tank through a cell stack of the flow cell battery;
wherein each of the top, bottom and each intermediate electrolyte tank comprises at least one respective gas connection for flowing gas in and/or out of the respective tank; and
the electrolyte tank system further comprises a flowing system for controlling a flow of electrolyte from each intermediate electrolyte tank to the top electrolyte tank, and from the top electrolyte tank, through the cell stack, to the bottom electrolyte tank, and from the bottom electrolyte tank to each intermediate electrolyte tank.

24. The flow cell battery of claim 23, wherein the electrolyte tank system is arranged on a first side of the cell stack.

25. The flow cell battery of claim 23, wherein the second fluid communication comprises a controllable fluid flow restrictor.

26. The flow cell battery of claim 23, wherein the flowing system is arranged between the cell stack and the bottom electrolyte tank.
